(19) United States
(12) Patent Application Publication
(10) Pub. No.: US 2002/0051954 A1
(43) Pub. Date: May 2, 2002

(54) SYSTEM FOR ASSISTING A USER WITH A SPEECH DISORDER

(76) Inventors: THOMAS E. HANES, BRENTWOOD, TN (US); JULIE A. HANES, BRENTWOD, TN (US)

Correspondence Address: RICHARD S. MYERS, WADDEY & PATTERSON, BANK OF AMERICA PLAZA, 414 UNION STREET, SUITE 2020, NASHVILLE, TN, 37219, US

(21) Appl. No.: 09/042,425

(22) Filed: Mar. 13, 1998

(51) Int. Cl. G09B 19/04

(52) U.S. Cl. 434/185

(57) ABSTRACT

The present invention discloses a system for assisting a user with a speech disorder. This system generally consists of a microphone connected electronically or by radio to an ear plug. The microphone receives the voice signal from the user and transmits it to the ear plug. At either the microphone or the ear plug or a third device, the voice signal is altered so that the frequency is changed. This allows the user to hear what he or she is saying but at a different pitch.

### BACKGROUND OF THE INVENTION

The present invention relates generally to a speech training system and more particularly to a system for assisting a user with a speech disorder.

It will be appreciated by those skilled in the art that individuals having a speech disorder such as stuttering or stammering generally tend to listen to their own voice too much. As a result, the prior art has attempted to create light noise or feedback which prevents the individual from hearing what he or she is saying. Examples of this are disclosed in U.S. Pat. Nos. 3,566,858; 3,881,059; 4,020,567; 5,125,032: 3,349,179; 4,662,847; 4,784,115; 3,773,032: 4,143,648; 4,421,488; 3,867,770; 4,464,119; 5,213,553; 5,257,930; 3,566,858; 5,169,316; 4,020,567; 3,626,607; and 3,920,903. Unfortunately, this can be very disconcerting to the individual because the individual is incapable of hearing his or her own voice at all.

What is needed, then, is a device which allows a user to hear what he or she is saying. This needed system must aid a user with a speech disorder such as stuttering or stammering. This system must be equally concealed. This system is presently lacking in the prior art.

### SUMMARY OF THE INVENTION

The present invention discloses a system for assisting a user with a speech disorder. This system generally consists of a microphone connected electronically or by radio to an ear plug. The microphone receives the voice signal from the user and transmits it to the ear plug. At either the microphone or the ear plug or a third device, the voice signal is altered so that the frequency is changed. This allows the user to hear what he or she is saying but at a different pitch.

Accordingly, one object of the present invention is to provide a system for assisting a user with a speech disorder.

Another object of the present invention is to provide a system which is easily concealed.

A further object of the present invention is to provide a system which can easily be manufactured.

### BRIEF DESCRIPTION OF THE DRAWINGS

FIG. 1 is a side view of the user wearing the system of the present invention.

FIG. 2 is a block diagram of the system of the present invention.

### DESCRIPTION OF THE PREFERRED EMBODIMENTS

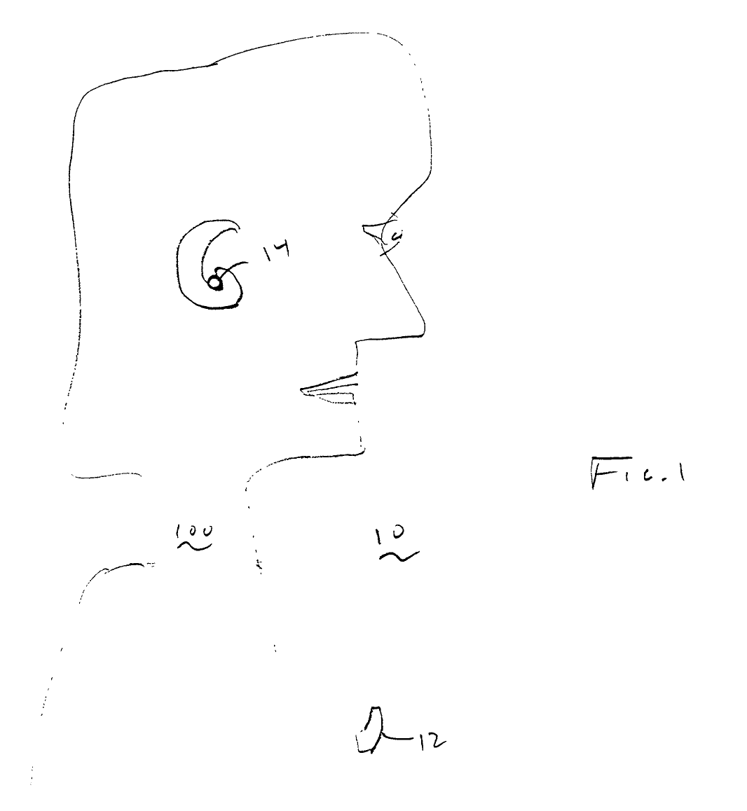

Referring now to FIG. 1, there is shown generally at 10 the system for assisting a user having a speech disorder. As can be seen, user 100 wears microphone 12 to pick up voice signals from user 100. The voice signals, as shown later, are altered at some point so that ear plug 14 replays what is being said by user 100 in real time at a different pitch.

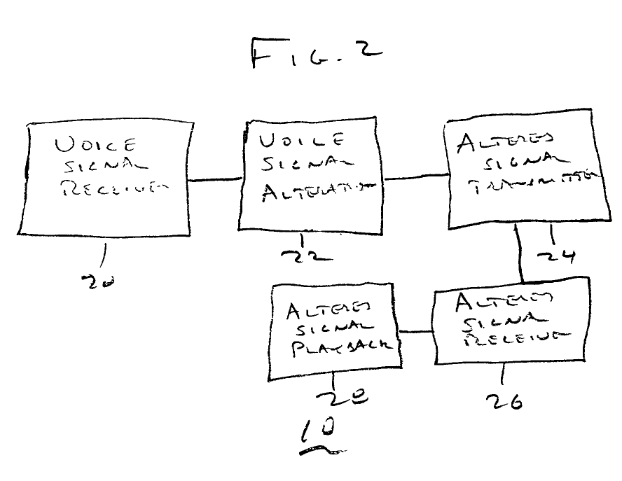

Referring now to FIG. 2, there is shown generally at 10 a block diagram of the system of the present invention. Voice signal from user (100 in FIG. 1) is received by voice signal receiver 20. The signal is then transferred to voice signal alteration 22 which changes the pitch of voice signal received by receiver 20. The altered signal is then transmitted by altered signal transmitter to altered signal receiver 20. Altered signal is then played back using altered signal playback 28 so that user (100 in FIG. 1) can hear what he or she is saying in real time. FIG. 2 is set up such that voice signal alteration 22 and altered signal transmitter 24 reside in microphone (12 in FIG. 1). However, these items 22, 24 may also reside in a third device which is electronically connected to microphone (12 in FIG. 1) or voice signal alteration 22 may actually reside in ear plug (14 in FIG. 1).

In the preferred embodiment, microphone 12 is the type manufactured by Audio-Technic under the model name ATH-COM1. In the preferred embodiment, ear plug 14 is preferably of the type manufactured by Audio-Technic under the model name ATH-COM1. In the preferred embodiment, voice signal alteration 22 is circuits such as a Model PXI Tone Works by Korg. In the preferred embodiment, altered signal transmitter 24 is of the type preferably disclosed by Korg Model PXI Tone Works by Korg. In the preferred embodiment, altered signal receiver 26 is combined with earplug.

Thus, although there have been described particular embodiments of the present invention of a new and useful system for assisting a user with a speech disorder, it is not intended that such references be construed as limitations upon the scope of this invention except as set forth in the following claims.

What is claimed is:

1. A system for assisting a user with a speech disorder comprising:
a. means for receiving a speech signal from said user;
b. means for altering said speech signal; and
c. means for transmitting said altered speech signal to said user.

2. The system of claim 1 wherein said means for receiving a speech signal from said user comprises a microphone.

3. The system of claim 1 wherein said means for altering said speech signal comprises an electronic circuit.

4. The system of claim 1 wherein said means for altering said speech signal alters the pitch of said speech signal.

5. The system of claim 1 wherein said means for transmitting said altered speech signal to said user comprises:
a. a transmitter electronically attached to said means for altering said speech signal; and
b. means for receiving said altered speech signal from said transmitter.

6. The system of claim 1 further comprising an ear plug. The system of claim 5 further comprising an ear plug.
